(19) United States
(12) Patent Application Publication
(10) Pub. No.: US 2017/0351655 A1
(43) Pub. Date: Dec. 7, 2017

(54) TEMPLATE-AWARE DOCUMENT EDITING

(71) Applicant: Google Inc., Mountain View, CA (US)

(72) Inventors: Wentao Zheng, Jersey City, NJ (US); Micah Lemonik, Great Neck, NY (US)

(73) Assignee: Google Inc., Mountain View, CA (US)

(21) Appl. No.: 14/016,558

(22) Filed: Sep. 3, 2013

(51) Int. Cl. G06F 17/24

(52) U.S. Cl. CPC G06F 17/248

(57) ABSTRACT

A method and apparatus for performing template-aware document editing is provided. Template-aware document editing may include identifying a document template, the document template including a plurality of rules, generating a document based on the document template, the document including a plurality of document tokens, wherein generating the document includes generating a document tree based on the plurality of rules, altering the document tree in response to user input based on the plurality of rules, and storing or transmitting the document.

### TECHNICAL FIELD

This application relates to computer implemented applications, particularly creating, modifying, and displaying information in an electronic representation of a document.

### BACKGROUND

Productivity applications, such as word processing applications and spreadsheet applications, may execute on a local computing device. Networked productivity applications may process and store documents at a central location, may reduce resource utilization at the local computing device, and may allow access from multiple devices and device types. Accordingly, it would be advantageous to provide template-aware document editing.

### SUMMARY

Disclosed herein are aspects of systems, methods, and apparatuses for template-aware document editing.

An aspect is a method for template-aware document editing. Template-aware document editing may include identifying a document template, the document template including a plurality of rules, generating a document based on the document template, the document including a plurality of document tokens, wherein generating the document includes generating a document tree based on the plurality of rules, altering the document tree in response to user input based on the plurality of rules, and storing or transmitting the document.

Another aspect is a method for template-aware document editing. Template-aware document editing may include identifying a document template, the document template including a plurality of rules, wherein each rule in the plurality of rules includes an object and an object definition for the object, wherein a first rule from the plurality of rules includes a first object and an object definition for the first object, and wherein the object definition for the first object includes a second object. Template-aware document editing may include generating a document based on the document template, the document including a plurality of document tokens, wherein generating the document includes generating a document tree based on the plurality of rules and the document, altering the document tree in response to user input based on the plurality of rules, and storing or transmitting the document.

Another aspect is a method for template-aware document editing. Template-aware document editing may include identifying a document template, the document template including a plurality of rules, wherein each rule in the plurality of rules includes an object and an object definition for the object, wherein a first rule from the plurality of rules includes a first object and an object definition for the first object, and wherein the object definition for the first object includes a second object. Template-aware document editing may include generating a document based on the document template, the document including a plurality of document tokens, wherein generating the document includes generating a document tree based on the plurality of rules and the document, wherein the plurality of rules includes a sequence, and wherein generating the document tree includes processing the plurality of rules based on the sequence. Template-aware document editing may include altering the document tree in response to user input based on the plurality of rules, and storing or transmitting the document.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of a computing device in accordance with implementations of this disclosure;

FIG. 2 is a diagram of a computing and communications system in accordance with implementations of this disclosure;

FIG. 3 is a diagram of a communication system for a networked application in accordance with implementations of this disclosure;

FIG. 4 is a block diagram of template-aware document editing in accordance with implementations of this disclosure; and

FIGS. 5-11 are diagrams of examples of interfaces for template-aware document editing of a document generated based on a template in accordance with implementations of this disclosure.

### DETAILED DESCRIPTION

Productivity applications, such as word processing applications and spreadsheet applications may allow for the creation and modification of documents and document templates. Document templates may provide guidance for organizing and presenting information in documents. However, the content, organization, and presentation of the information in a document created based on a template may vary from the structure and style indicated by the template.

Productivity applications implementing template-aware document editing may allow for the creation and modification of document templates and for the creation and modification documents in conformity with the document templates. Document templates may include rules describing objects, and object definitions. Rules may describe relationships between objects, and may include content, such as string data that may be incorporated into documents generated based on the respective template.

A productivity application may generate a document based on a template, and may provide an interface for presenting and modifying the document. The presentation, organization, and validation of the document may be based on input received by the productivity application, such as user input, the content of the document, and the rules described by the template. The productivity application may generate a document tree based on the rules defined in the template and the content included in the document, and may generate the interface based on the document tree.

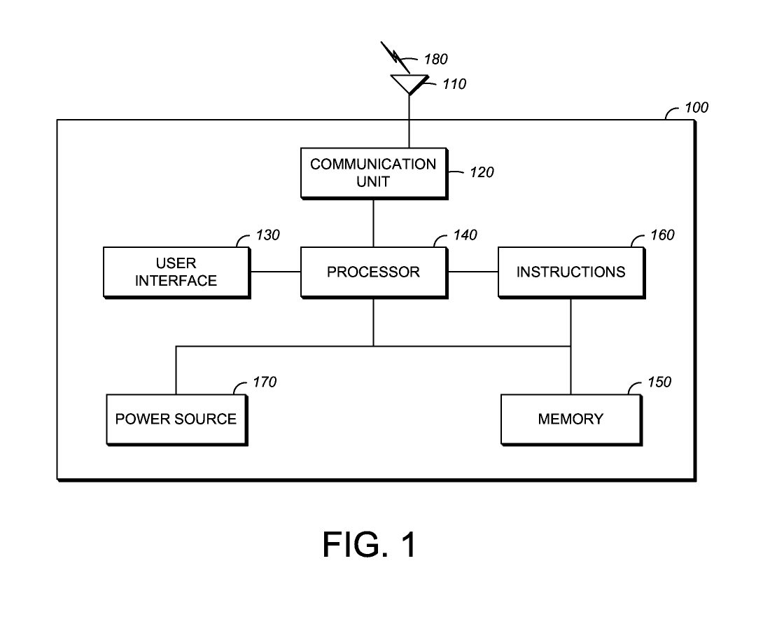

FIG. 1 is a diagram of a computing device 100 in accordance with implementations of this disclosure. A computing device 100 can include a communication interface 110, a communication unit 120, a user interface (UI) 130, a processor 140, a memory 150, instructions 160, a power source 170, or any combination thereof. As used herein, the term “computing device” includes any unit, or combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one or more element of the communication device 100 can be integrated into any number of separate physical units. For example, the UI 130 and processor 140 can be integrated in a first physical unit and the memory 150 can be integrated in a second physical unit.

The communication interface 110 can be a wireless antenna, as shown, a wired communication port, such as an Ethernet port, an infrared port, a serial port, or any other wired or wireless unit capable of interfacing with a wired or wireless electronic communication medium 180.

The communication unit 120 can be configured to transmit or receive signals via a wired or wireless medium 180. For example, as shown, the communication unit 120 is operatively connected to an antenna configured to communicate via wireless signals. Although not explicitly shown in FIG. 1, the communication unit 120 can be configured to transmit, receive, or both via any wired or wireless communication medium, such as radio frequency (RF), ultra violet (UV), visible light, fiber optic, wire line, or a combination thereof. Although FIG. 1 shows a single communication unit 120 and a single communication interface 110, any number of communication units and any number of communication interfaces can be used.

The UI 130 can include any unit capable of interfacing with a user, such as a virtual or physical keypad, a touchpad, a display, a touch display, a speaker, a microphone, a video camera, a sensor, or any combination thereof. The UI 130 can be operatively coupled with the processor, as shown, or with any other element of the communication device 100, such as the power source 170. Although shown as a single unit, the UI 130 may include one or more physical units. For example, the UI 130 may include an audio interface for performing audio communication with a user, and a touch display for performing visual and touch based communication with the user. Although shown as separate units, the communication interface 110, the communication unit 120, and the UI 130, or portions thereof, may be configured as a combined unit. For example, the communication interface 110, the communication unit 120, and the UI 130 may be implemented as a communications port capable of interfacing with an external touchscreen device.

The processor 140 can include any device or system capable of manipulating or processing a signal or other information now-existing or hereafter developed, including optical processors, quantum processors, molecular processors, or a combination thereof. For example, the processor 140 can include a general purpose processor, a special purpose processor, a conventional processor, a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors. The processor can be operatively coupled with the communication interface 110, communication unit 120, the UI 130, the memory 150, the instructions 160, the power source 170, or any combination thereof.

The memory 150 can include any non-transitory computer-usable or computer-readable medium, such as any tangible device that can, for example, contain, store, communicate, or transport the instructions 160, or any information associated therewith, for use by or in connection with the processor 140. The non-transitory computer-usable or computer-readable medium can be, for example, a solid state drive, a memory card, removable media, a read only memory (ROM), a random access memory (RAM), any type of disk including a hard disk, a floppy disk, an optical disk, a magnetic or optical card, an application specific integrated circuits (ASICs), or any type of non-transitory media suitable for storing electronic information, or any combination thereof. The memory 150 can be connected to, for example, the processor 140 through, for example, a memory bus (not explicitly shown).

The instructions 160 can include directions for performing any method, or any portion or portions thereof, disclosed herein. The instructions 160 can be realized in hardware, software, or any combination thereof. For example, the instructions 160 may be implemented as information stored in the memory 150, such as a computer program, that may be executed by the processor 140 to perform any of the respective methods, algorithms, aspects, or combinations thereof, as described herein. The instructions 160, or a portion thereof, may be implemented as a special purpose processor, or circuitry, that can include specialized hardware for carrying out any of the methods, algorithms, aspects, or combinations thereof, as described herein. Portions of the instructions 160 can be distributed across multiple processors on the same machine or different machines or across a network such as a local area network, a wide area network, the Internet, or a combination thereof.

The power source 170 can be any suitable device for powering the communication device 110. For example, the power source 170 can include a wired power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the communication device 110. The communication interface 110, the communication unit 120, the UI 130, the processor 140, the instructions 160, the memory 150, or any combination thereof, can be operatively coupled with the power source 170.

Although shown as separate elements, the communication interface 110, the communication unit 120, the UI 130, the processor 140, the instructions 160, the power source 170, the memory 150, or any combination thereof can be integrated in one or more electronic units, circuits, or chips.

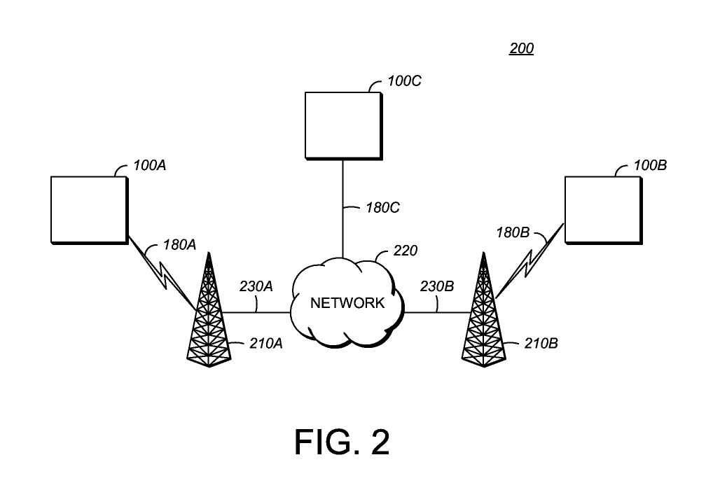

FIG. 2 is a diagram of a computing and communications system 200 in accordance with implementations of this disclosure. The computing and communications system 200 may include one or more computing and communication devices 100A/100B/100C, one or more access points 210A/210B, one or more networks 220, or a combination thereof. For example, the computing and communication system 200 can be a multiple access system that provides communication, such as voice, data, video, messaging, broadcast, or a combination thereof, to one or more wired or wireless communicating devices, such as the computing and communication devices 100A/100B/100C. Although, for simplicity, FIG. 2 shows three computing and communication devices 100A/100B/100C, two access points 210A/210B, and one network 220, any number of computing and communication devices, access points, and networks can be used.

A computing and communication device 100A/100B/100C can be, for example, a computing device, such as the computing device 100 shown in FIG. 1. For example, as shown the computing and communication devices 100A/100B may be user devices, such as a mobile computing device, a laptop, a thin client, or a smartphone, and computing and the communication device 100C may be a server, such as a mainframe or a cluster. Although the computing and communication devices 100A/100B are described as user devices, and the computing and communication device 100C is described as a server, any computing and communication device may perform some or all of the functions of a server, some or all of the functions of a user device, or some or all of the functions of a server and a user device.

Each computing and communication device 100A/100B/100C can be configured to perform wired or wireless communication. For example, a computing and communication device 100A/100B/100C can be configured to transmit or receive wired or wireless communication signals and can include a user equipment (UE), a mobile station, a fixed or mobile subscriber unit, a cellular telephone, a personal computer, a tablet computer, a server, consumer electronics, or any similar device. Although each computing and communication device 100A/100B/100C is shown as a single unit, a computing and communication device can include any number of interconnected elements.

Each access point 210A/210B can be any type of device configured to communicate with a computing and communication device 100A/100B/100C, a network 220, or both via wired or wireless communication links 180A/180B/180C. For example, an access point 210A/210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A/210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the Hyper Text Transport Protocol (HTTP), or a combination thereof.

The computing and communication devices 100A/100B/100C can communicate with each other via the network 220 using one or more a wired or wireless communication links, or via a combination of wired and wireless communication links. For example, as shown the computing and communication devices 100A/100B can communicate via wireless communication links 180A/180B, and computing and communication device 100C can communicate via a wired communication link 180C. Any of the computing and communication devices 100A/100B/100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A/210B can communicate with the network 220 via one or more types of wired or wireless communication links 230A/230B. Although FIG. 2 shows the computing and communication devices 100A/100B/100C in communication via the network 220, the computing and communication devices 100A/100B/100C can communicate with each other via any number of communication links, such as a direct wired or wireless communication link.

Other implementations of the computing and communications system 200 are possible. For example, in an implementation the network 220 can be an ad-hock network and can omit one or more of the access points 210A/210B. The computing and communications system 200 may include devices, units, or elements not shown in FIG. 2. For example, the computing and communications system 200 may include many more communicating devices, networks, and access points.

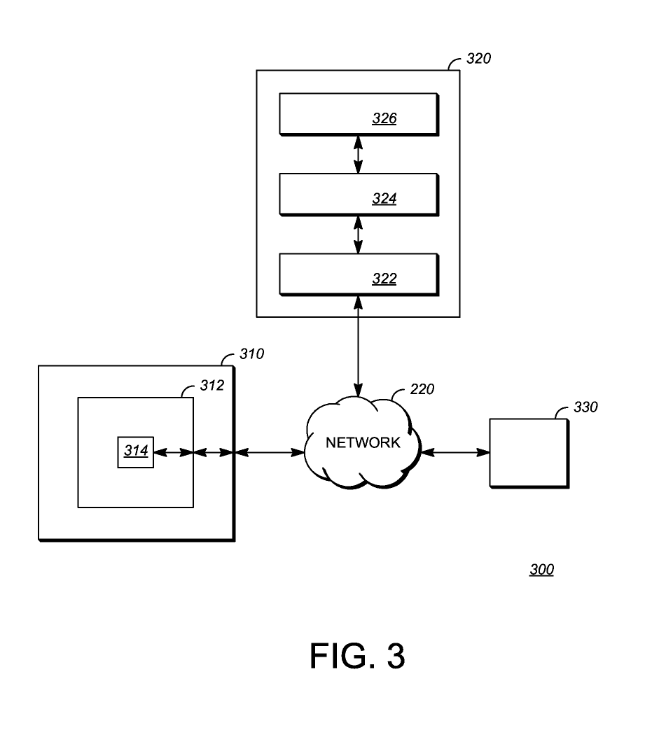

FIG. 3 is a diagram of a communication system for a networked application 300 in accordance with implementations of this disclosure. Executing the networked application 300 may include a user device 310, which may be a computing device, such as the computing device 100 shown in FIG. 1 or the computing and communication devices 100A/100B shown in FIG. 2, communicating with a server 320, which may be a computing device, such as the computing device 100 shown in FIG. 1 or computing and communication device 100C shown in FIG. 2, via a network 330, such as the network 220 shown in FIG. 2.

In some implementations, the server 320 may execute a portion or portions of the networked application 300, which may include, for example, generating, modifying, and storing documents and information related to the documents, such as metadata, and providing information for displaying and interacting with the networked application 300 to the user device 310. In some implementations, the server 320 may include one or more logical units 322/324/326. For example, the server 320 may include a web server 322 for receiving and processing requests, such as HTTP requests, from user devices; an application server 324 for executing applications, such as a spreadsheet application or a word processing application; and a database 326 for storing and managing data, such as documents or information about documents, such as metadata. In some implementations, the server 320 may provide information for the networked application 300 to the user device 310 using one or more protocols, such as HyperText Markup Language (HTML), Cascading Style Sheets (CSS), Extensible Markup Language (XML), or JavaScript Object Notation (JSON).

The user device 310 may execute a portion or portions of the networked application 300. For example, the user device 310 may execute a local application 312, such as a browser application, which may receive information from the server 320 and may present a representation of an interface 314 for displaying the networked application 300 and user interactions therewith. For example, the user device 310, may execute a browser application, the browser application may send a request, such as an HTTP request, for the networked application 300 to the server 320, the browser may receive information for presenting the networked application 300, such as HTML and XML data, and the browser may present an interface for the networked application 300. The user device 310 may execute portions of the networked application 300, which may include executable instructions, such as JavaScript, received from the server 320. The user device 310 may receive user input for the networked application 300, may update the interface 314 for the networked application 300 in response to the user input, and may send information for the networked application 300, such as information indicating the user input, to the server 320.

In some implementations, a portion or portions of the networked application may be cashed at the user device 310. For example, the user device 310 may execute a portion or portions of the networked application 300 using information previously received from the server 320 and stored on the user device 310. Although the user device 310 and the server 320 are shown separately, they may be combined. For example, a physical device, such as the computing device 100 shown in FIG. 1 may execute the user device 310 as a first logical device and may execute the server 320 as a second logical device.

In some implementations, the networked application 300 may generate files, folders, or documents, such as spreadsheets or word processing documents. The files, folders, or documents, may be created and stored on the user device 310, the server 320, or both. For example, a document may be created and stored on the server 320 and a copy of the document may be transmitted to the user device 310. Modifications to the document may be made on the user device 310 and transmitted to the server 320. In another example, a document may be created and stored on the user device 310 and the document, or modifications to the document, may be transmitted to the server 320.

In some implementations, a networked application, or an element thereof, may be accessed by multiple user devices. For example, the networked application 300 may be executed by a first user device 310 in communication with the server 32, and a document may be stored at the server 320. The networked application 300 may be executed by a second user device 340, which may be a computing device, such as the computing device 100 shown in FIG. 1 or the computing and communication devices 100A/100B shown in FIG. 2, a user may input modifications to the document at the second user device 340, and the modifications may be saved to the server 320.

In some implementation, a networked application, or an element thereof, may be collaboratively accessed by multiple user devices. For example, a first user device 310 may execute a first instance of the networked application 300 in communication with the server 320, and a document may be stored at the server 320. The first user device 310 may continue to display or edit the document. The second user device 340 may concurrently, or substantially concurrently, execute a second instance of the networked application 300, and may display or edit the document. User interactions with the document at one user device may be propagated to collaborating user devices. For example, one or both of the user devices 310/340 may transmit information indicating user interactions with the document to the server 320, and the server may transmit the information, or similar information, to the other user device 310/340. Although FIG. 3 shows two user devices, any number of user devices may collaborate. User interactions with the networked application 300 at one user device may be propagated to collaborating user devices in real-time, or near real-time. Some user interactions with the networked application 300 may not be transmitted to the server 320 and may not be propagated to the collaborating user devices.

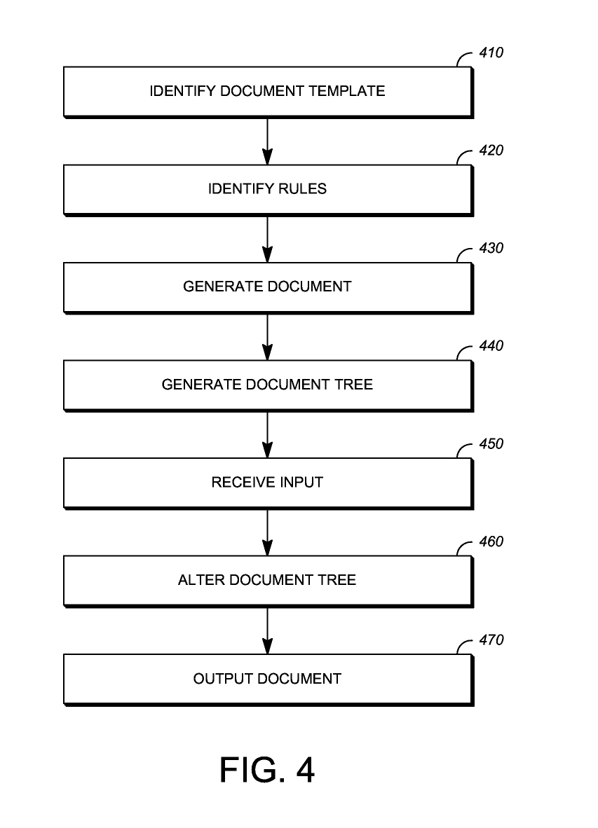

FIG. 4 is a block diagram of template-aware document editing in accordance with implementations of this disclosure. Implementations of template-aware document editing may include one or more user devices, such as the computing device 100 shown in FIG. 1 or the computing and communication devices 100A/100B shown in FIG. 2, creating, accessing, or editing one or more documents via a productivity application, which may be a networked application, such as the networked application 300 shown in FIG. 3, executed by a server, which may be a computing device, such as the computing device 100 shown in FIG. 1 or the computing and communication devices 100C shown in FIG. 2. Implementations of template-aware document editing can include identifying a document template at 410, identifying rules at 420; generating a document at 430, generating a document tree at 440, receiving input at 450, altering the document tree at 460, outputting the document at 470, or a combination thereof.

In some implementations, a document template may be identified at 410. For example, a user may initiate a productivity application, such as a networked productivity application, and a document template may be identified in response to user input indicating the document template, such as the selection of a document template from a list of document templates. In some implementations, identifying a document template may include identifying a document associated with the template, and identifying the template based on the document.

In some implementations, identifying a document template may include identifying a template specification associated with the document template. In some implementations, a template specification may describe the organization and presentation of documents generated based on the template. For example, the template specification may include template rules.

In some implementations, template rules may be identified at 420. For example, a template identified at 410 may be associated with a template specification that may include template rules. For example, a template for task documents may include rules which may be expressed as the following:

TaskList=Task+

Task=Status Title Description?

Status=(Pending|Finished)

Pending=“TODO”

Finished=“DONE”

Title=text

Description=text+ [Template 1]

Although each rule in Template 1 is delimited on an individual line, rules may be delimited using any symbol, or combination of symbols, which may include whitespace, capable of distinguishing rules. For example, a semicolon may be used to delimit rules, such that the first two rules of the template specification shown in Template 1 may be expressed as the following:

TaskList=Task+; Task=Status Title Description?; [Template 1b]

In some implementations, a rule, such as the first rule in a template specification may include an identifier of the template, such as a name of the template. For example, in Template 1, the first rule “TaskList=Task+” includes a name for the template ‘TaskList’.

In some implementations, a rule may indicate an object and an object definition, or replacement setting, for the object. For example, in Template 1, the first rule “TaskList=Task+” may indicate an object, ‘TaskList’, and an object definition, “Task+”. In some implementations, an object, which may represent a discrete collection of information, may be expressed as a symbol, such as ‘TaskList’, which may be a terminal or nonterminal symbol. In some implementations, an object definition may be expressed as an expression that may include one or more symbols, such as objects and modifiers. Although rules are described herein using the equality operator (=) to distinguish an object from an object definition, any symbol, or combination of symbols, which may include whitespace, capable of distinguishing an object from an object definition may be used. For example, the first rule shown in Template 1 may be expressed as “TaskList:Task+”.

In some implementations, an object definition may include one or more objects, such as system objects, which may be expressed as terminal symbols, or custom objects, which may be expressed as nonterminal symbols. For example, a template specification may include the rule “Task=Title” and the rule “Title=text”. The object definition indicated in the rule “Task=Title” includes the ‘Title’ object, which may be a custom object, such as an object that is defined in another rule in the template specification, such as the rule “Title=text”. The object definition indicated in the rule “Title=text” includes the ‘text’ object, which may be a system object.

In some implementations, a custom object may be defined in the template specification. For example, in Template 1, the custom object ‘Task’ may be defined by the second rule “Task=Status Title Description?”, which may indicate that the ‘Task’ object may include a ‘Status’ object, a ‘Title’ object, and a ‘Description’ object. In some implementations, a template specification may include a rule defining each custom object.

In some implementations, an object definition for a system object may be omitted from a template specification. For example, in Template 1, the rule “Title=text” may indicate that the object ‘Title’ may include the system object ‘text’. In some implementations, the productivity application may define one or more system objects. For example, the system object ‘text’ may be defined by the productivity application as a paragraph of text.

In some implementations, an object indicated in an object definition may be associated with one or more modifiers. For example, the one-or-more modifier, which may be expressed as using, for example, the plus symbol (+), may be associated with an object and may indicate that a document generated based on the template may include one-or-more of the object. For example, the rule “Task Template=Task+” may indicate that the ‘TaskList’ object may include one or more ‘Task’ objects.

In some implementations, the zero-or-more modifier, which may be expressed using, for example, the asterisk (*), may be associated with an object and may indicate that a document generated based on the template may include zero or more of the object. For example, the rule “Task=text*”, may indicate that the ‘Task’ object may include zero-or-more ‘text’ objects. In some implementations, a modifier may indicate the minimum and maximum instances of an object in a document generated based on a template. For example, the modifier {2,4} may indicate that a document may include two, three, or four instances of an object.

In some implementations, the optional modifier, which may be expressed using, for example, the question mark (?), may be associated with an object and may indicate that the object is optional. For example, in Template 1, the second rule “Task=Status Title Description?”, may indicate that the ‘Task’ object may include a ‘Status’ object, a ‘Title’ object, and an optional ‘Description’ object.

In some implementations, the set modifier, which may be expressed using an opening parenthesis and a closing parenthesis (( )), may be associated with a set of objects and may indicate that the objects are related. In some implementations, the alternate modifier, which may be expressed using, for example, a vertical line (|), may be associated with a set of objects and may indicate that the objects are alternates. For example, in Template 1, the third rule “Status=(Pending|Finished)” may indicate that the ‘status’ object may include a ‘Pending’ object or a ‘Finished’ object. In some implementations, the alternates modifier may be used in combination with the set modifier, as shown in the third rule of Template 1. In some implementations, the alternates modifier may be used independently of the set modifier. For example, the third rule of Template 1 may be expressed as “Status=Pending|Finished”. Although the objects associated with the alternates modifier are shown in Template 1 as having object definitions that include express content, objects associated with the alternate modifier may have object definitions that include placeholder content or that do not include content.

In some implementations, an object definition may include content, such as express content, which may be included in a document associated with the template, or placeholder content, which may be omitted from a document associated with the template and may be included in a user interface for the document. In some implementations, the content may be defined as a string of text using the string modifier, which may be expressed as a pair of quotation marks (“ ”).

In some implementations, an object definition may include express content as a string that is not associated with an object in the object definition. For example, a template may include the rule “Pending=“TODO””, which may indicate that the ‘Pending’ object includes an implicit ‘text’ object that is associated with the express content “TODO”, and a document generate based on the template 1 may include the express content “TODO”.

In some implementations, an object definition may include placeholder content as a string that is associated with an object in the object definition. For example, a template may include the rule “Title=text[“Title”]”, which may indicate that the ‘Title’ object includes a ‘text’ object that is associated with the placeholder content “Title”, generating a document based on the template may include omitting the placeholder content, and a user interface for the document may include the placeholder content as a placeholder token.

In some implementations, an object definition may include presentation information, such as cascading style sheet information, or any other information capable of describing the presentation of content. For example, a rule including style information may be expressed as the following:

[Template 1c]

```
Title = text[″Title″]{
  font-size: 1.2em;
  text-align: center;
  line-height: 1.8;
  font-weight: bold;
};
```

In some implementations, a document may be generated at 430. For example, generating a document may include creating a file in a file system, creating a document record in a database, or otherwise creating a discrete container for containing document information. In some implementations, generating a document at 430 may include associating the document with the template. For example, a template identifier indicating the template may be included in the document information, such as in metadata, or an association between the document and the template may be stored in a table, such as a database table.

In some implementations, a document generated based on a template may be modeled as a sequence of tokens corresponding to the rules indicated in the associated template specification. In some implementations, the objects indicated in the template specification may be included in the document as object instances and may be represented by tokens. In some implementations, a token may be delimited using a pair of square brackets, or any other symbol, including whitespace, capable of delimiting tokens. For example, a document associated with Template 1 may be expressed, in part, as the following:

[TaskList] [Task] [Status] [Pending] [text]TODO[Title] [text]A Task Title [Description] [text] [Model 1]

In some implementations, an object instance may be associated with content, such as document content, express content, placeholder content, or a combination thereof. For example, a document generated based on a template that includes the rule “Pending=“TODO”” may include a [Pending] token, representing an instance of a ‘Pending’ object, which may include a [text] token, representing an instance of a ‘text’ object, which may include the express content “TODO”.

In some implementations, objects, such as objects associated with the optional modifier or objects associated with the zero-or-more modifier, may be omitted from the document. For example, in Template 1 the ‘Description’ object is associated with the optional modifier, and generating a document based on Template 1 may include omitting a token representing an instance of the ‘Description’ object. In some implementations, omitting an object may include omitting objects defined in the object definition for the omitted object.

In some implementations, objects, such as objects that are not associated with a modifier or objects associated with the one-or-more modifier, may be included in the document. For example, as shown in Model 1, an instance of an object, such as the ‘Title’ object may be included in the document as an object token, such as the [Title] token.

In some implementations, a document associated with a template may be validated for conformity with the corresponding template specification. For example, the validation may include performing a deserialization analysis.

In some implementations, a document tree may be generated at 440. In some implementations, generating a document tree at 440 may include identifying content from a document, such as the document generated at 430, and applying the rules included in the template specification, such as the rules identified at 420, to the document content. For example, the template may include the objects associated with the alternate modifier, such as the ‘Pending’ object and the ‘Finished’ object indicated in Template 1, and generating the document tree may include identifying content in the document that is associated with ‘Pending’ object or the ‘Finished’ object, and including the identified content in the document tree.

In some implementations, the template specification may include an object that is associated with placeholder content, and generating the document tree at 440 may include generating a placeholder token for an instance of the object. In some implementations, a placeholder token may be expressed using a pair of angle brackets, or any other symbol, including whitespace, capable of delimiting a content placeholder. For example, a template may include the rule “Title=text[“Title”]”, which may indicate that the ‘Title’ object includes a ‘text’ object associated with the placeholder content “Title”, and a placeholder token for an instance of the ‘Title’ object may be expressed as “<Title>”. In some implementations, the template specification may include an object that does not include placeholder content, such as the ‘Title’ object shown in Template 1 (“Title=text”), and generating the document tree at 440 may include using an ellipsis, or any other symbol, including whitespace, capable of expressing a content placeholder.

For example, a partial document tree for a document associated with Template 1 may be expressed as the following:

[Tree 1]

```
TaskList
  Task
        Status
                Pending
                      text
                              TODO
        Title
                text
                      A first task title
        Description
                text
                      item 1 for task
                text
                      item 2 for task
  Task
        Status
                Pending
                      text
                              TODO
        Title
                text
                      . . .
```

For clarity, in Tree 1, object instances are shown in italic font, placeholder content is shown underlined, and document content is shown in normal font.

In some implementations, input may be received at 450. For example, the productivity application may generate and present an interface, such as a user interface, for interacting with the document generated at 430, which may include using the document tree generated at 440, and may receive input via the interface. In some implementations, the productivity application may receive input indicating, for example, a mouse click on a text field, a change of focus, a keystroke, such as the enter key or the tab key, a combination of keystrokes, such as shift-tab, alt-up, or alt-down, or any other input related to the document.

In some implementations, the document tree may be altered at 460. For example, the document tree may be altered in response to the input received at 450. In some implementations, alterations to the document tree may be based on a current state of the productivity application interface, the input received at 450, the template specification, or a combination thereof. For example, content may be added, modified, or removed from the document tree. In some implementations, the document may not include an instance of an object indicated in the corresponding template specification, such as the ‘Description’ object, and updating the document tree may include inserting the omitted object, corresponding content, or both, into the document tree.

In some implementations, the document may be output at 470. For example, the document may be stored on a memory, such as memory 150 shown in FIG. 1, or transmitted via a communication network, such as the network 220 shown in FIG. 2. In some implementations, outputting the document may include presenting an interface, such as a user interface, for viewing and interacting with the document. In some implementations, the document may be output based on the content of the document, the template, or both.

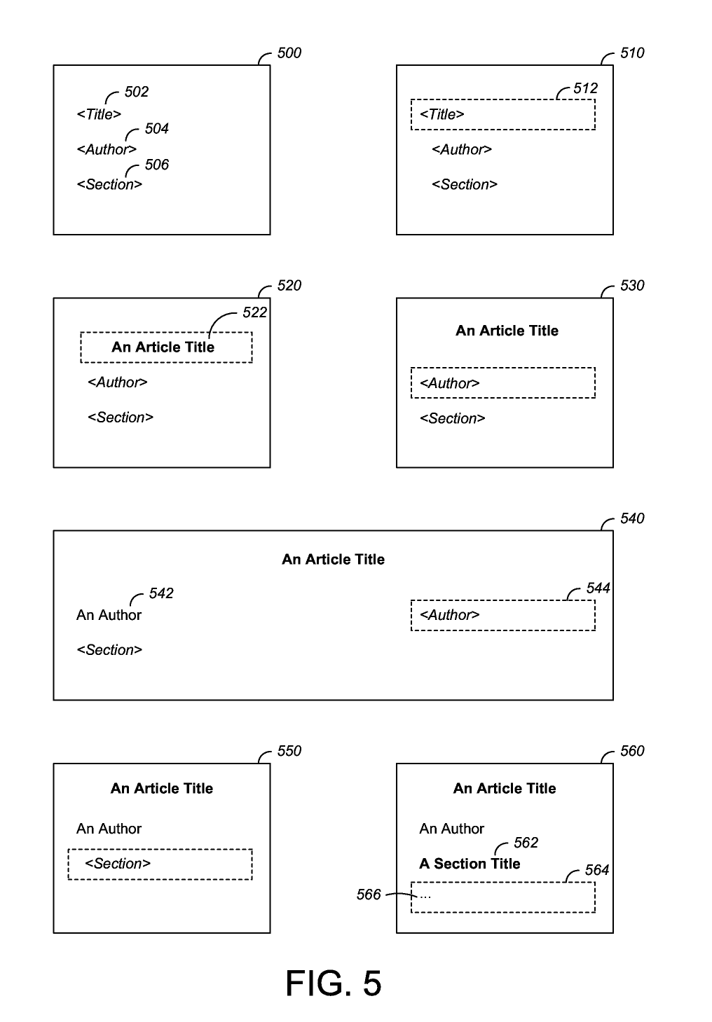

FIGS. 5-11 show examples of interfaces for template-aware document editing of a document generated based on a template in accordance with implementations of this disclosure. The aspects shown in FIGS. 5-11 may include receiving input, such as the input receiving shown at 450 in FIG. 4, altering a document tree, such as the document tree altering shown at 460 in FIG. 4, and outputting a document, such as the document outputting shown at 470 in FIG. 4.

For simplicity, FIGS. 5-7 are described in relation to Template 2, which may be expressed as the following:

Article=Title AuthorList Content

Title=text[“Title”]

AuthorList=Author+

Author=text[“Author”]

Content=Section+

Section=text[“Section”] Description?

Description=text+ [Template 2]

FIG. 5 shows a diagram of an example of a portion of an interface for template-aware document editing of a document generated based on a template in accordance with implementations of this disclosure. For example, a document generated based on Template 2 may be output as a document interface 500 as shown in FIG. 5.

In some implementations, the interface may include a placeholder token for an object. For example, the productivity application may identify a rule in the template specification indicating an object that does includes placeholder content, the productivity application may generate a document tree for a document associated with the template, which may include determining that the document includes placeholder content corresponding to the object, and the productivity application may output an interface for the document including the placeholder content as a placeholder token representing the object. In some implementations, the productivity application may distinguish a placeholder token from content of the document. For example, content may be output using a first style, such as black font color, and a placeholder indication may be output using a different style, such as grey font color, or an italicized font face. For example, FIG. 5 shows a placeholder token for the ‘Title’ object 502, a placeholder token for the first ‘Author’ object 504, and a placeholder token for the first ‘Section’ object 506. For clarity, the placeholder token for the ‘Title’ object 502, the placeholder token for the first ‘Author’ object 504, and the placeholder token for the first ‘Section’ object 506 are shown in FIG. 5 using italics.

In some implementations, the productivity application may receive input setting the interface focus on an object represented by a placeholder token, such as the ‘Title’ object. In some implementations, the interface may be updated to include a text entry interface element 512, as shown in document interface 510. In some implementations, the productivity application may update the document tree to include the text entry interface element 512, to indicate the current, in-focus, element, or both.

In some implementations, the productivity application may receive input indicating text, such as a string of one or more character keystrokes, entered into a text entry interface element, such as the text entry interface element 512 shown in document interface 510, and the interface may be updated to include the text 522 as shown in document interface 520. In some implementations, the interface may be updated to omit the placeholder token. In some implementations, the productivity application may update the document tree to include the received text, to omit the placeholder token, or both.

In some implementations, the productivity application may receive input removing focus from an object represented by a placeholder token, such as the text entry interface element 512 shown in object interface 510. For example, the productivity application may receive input indicating a key press for the ‘Enter’ or ‘Return’ key. In some implementations, the productivity application may set focus to another object, such as the ‘Author’ object, and may update the interface to indicate focus on the second object as shown in document interface 530. In some implementations, the productivity application may update the document tree to indicate the current element.

In some implementations, the productivity application may determine whether an object is associated with a one-or-more modifier, and may determine whether the object is associated with content. For example, as shown in document interface 530, the ‘Author’ object may have focus, and the productivity application may receive input indicating text and a completion indicator, such as the ‘Enter’ or ‘Return’ key. The productivity application may determine that the ‘Author’ object is associated with a one-or-more modifier, and the productivity application may update the interface to include the text 542, to include another instance of the ‘Author’ object 544, and to set focus on the other instance of the ‘Author’ object 544 as shown in document interface 540. In some implementations, the productivity application may update the document tree to include the input text 542 and to include the second instance of the ‘Author’ object 544.

In another example, an object instance, such as the second ‘Author’ object 544, may have focus, the productivity application may receive input indicating a change in focus, such as a completion indicator, the productivity application may determine that the object is not associated with content, and the productivity application may update the interface to omit the object and set focus on another object, such as the ‘Section’ object, as shown in document interface 550. In some implementations, the productivity application may update the document tree to omit the second instance of the ‘Author’ object, to indicate the current element, or both.

In some implementations, the productivity application may determine whether an object, such as the ‘Section’ object, includes an object, such as the ‘Description’ object, that is associated with an optional modifier. For example, the ‘Section’ object may have focus, as shown in document interface 550, and the productivity application may receive input indicating text and a completion indicator, such as the ‘Enter’ or ‘Return’ key. The productivity application may update the interface, as shown in document interface 560, to include the input text 562, may determine that the ‘Section’ object includes a ‘Description’ object that is associated with the optional modifier, and may update the interface to include a text entry interface element associated with the optional object 564. In some implementations, the productivity application may update the interface to include a placeholder token 566, such as an ellipsis, representing the optional object. In some implementations, the productivity application may update the document tree to include the received text, to include the optional object, to include the placeholder token 566, or any combination thereof.

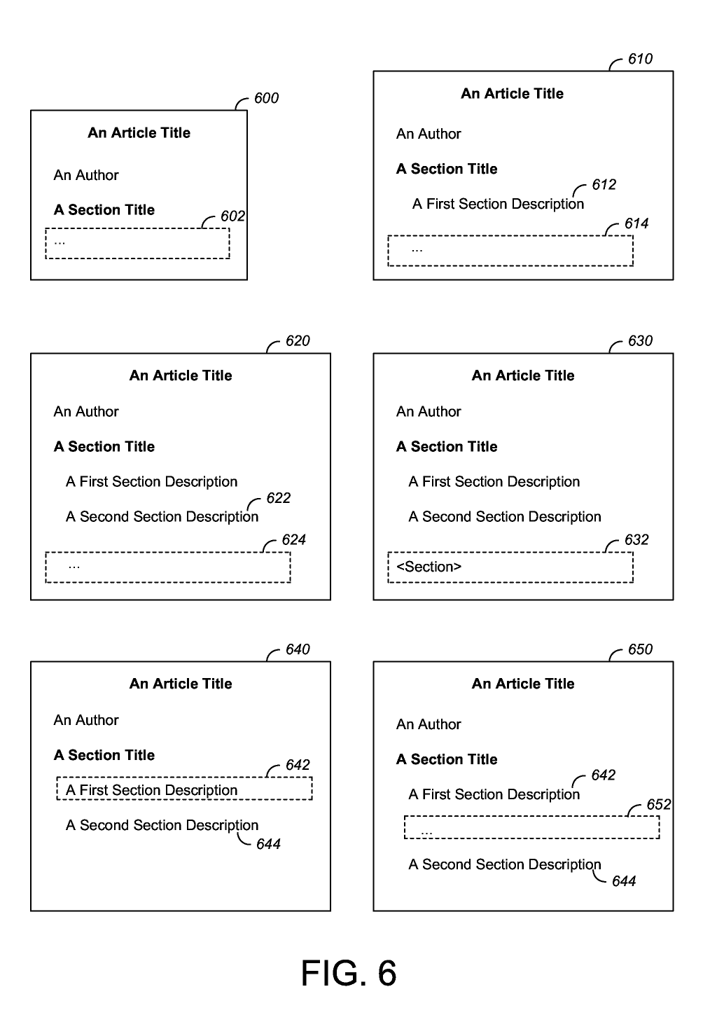

FIG. 6 shows another diagram of an example of a portion of an interface for template-aware document editing of a document generated based on a template in accordance with implementations of this disclosure. For example, a document generated based on Template 2 may be output as a document interface 600 as shown in FIG. 6.

In some implementations, the productivity application may determine that the document includes an instance of an object that is associated with a zero-or-more modifier or a one-or-more modifier, and the productivity application may include other instances of the object in the document. For example, an optional object, such as the optional description object 602 shown in document interface 600, may have focus, the productivity application may receive input indicating text and a completion indicator, and, as shown in document interface 610, the productivity application may update the interface to include the text 612 and to include another instance of the optional object 614. In some implementations, the productivity application may update the document tree to include the received text 612, the optional object 614, or both.

In another example, the second instance of the optional ‘Description’ object 614 may have focus, the productivity application may receive input indicating text and a completion indicator, and, as shown in document interface 620, the productivity application may update the interface to include the text 622, and to include a third instance of the optional ‘Description’ object 624. In some implementations, the productivity application may update the document tree to include the received text 622, the third instance of the optional ‘Description’ object 624, or both.

In another example, the third instance of the optional ‘Description’ object 624 may have focus, the productivity application may receive input indicating a completion indicator, the optional object may not be associated with content, and, as shown in document interface 630, the productivity application may update the interface to omit the optional ‘Description’ object and to include another instance of the ‘Section’ object 632. In some implementations, the productivity application may update the document tree to omit the optional ‘Description’ object 624, to include the other instance of the ‘Section’ object 632, or both.

In some implementations, the productivity application may insert an object between two objects. For example, as shown in document interface 640, the document may include content associated with a first ‘Description’ object 642, and content associated with a second ‘Description’ object 644 adjacent to the first ‘Description’ object in the interface. The first ‘Description’ object 642 may have focus, the productivity application may receive input including a completion indicator, and the productivity application may update the interface, as shown in document interface 650, to include a third ‘Description’ object 652, between the first ‘Description’ object 642 and the second ‘Description’ object 644. In some implementations, the productivity application may update the document tree to include the third instance of the ‘Description’ object 624.

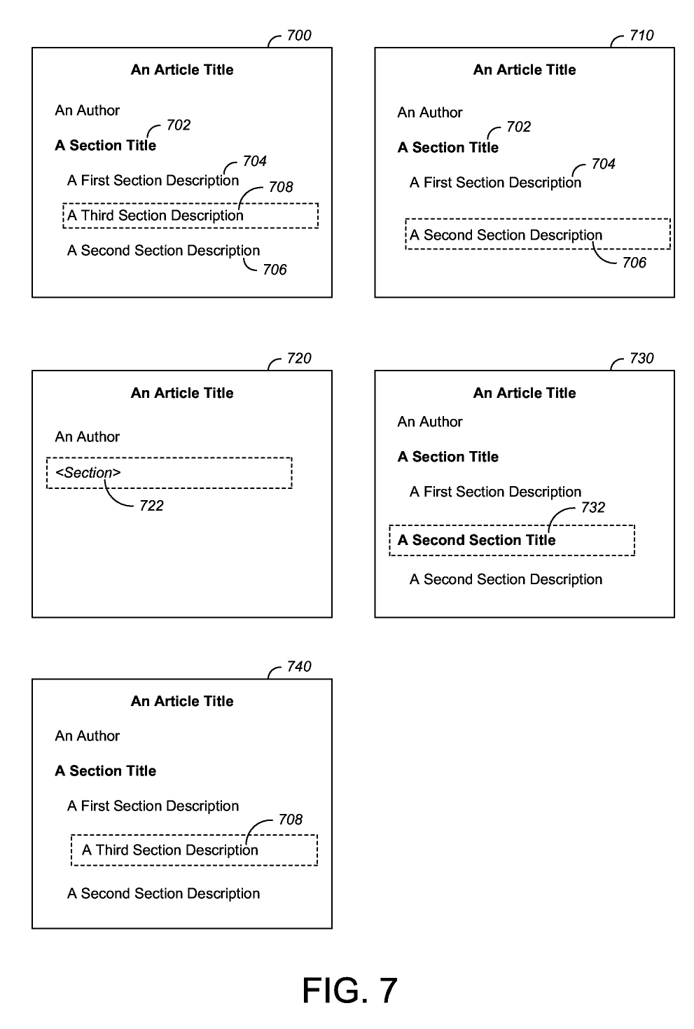

FIG. 7 shows another diagram of an example of a portion of an interface for template-aware document editing of a document generated based on a template in accordance with implementations of this disclosure. For example, a document generated based on Template 2 may be output as a document interface 700 as shown in FIG. 7.

In some implementations, the productivity application may remove an object. For example, as shown in document interface 700, a document may include a first ‘Section’ object 702, which may include a first ‘Description’ object 704, a second ‘Description’ object 706, and a third ‘Description’ object 708. The third ‘Description’ object 708 may have focus, and the productivity application may receive input indicating a deletion of the content associated with the third ‘Description’ object 708, which may include a completion indication. The productivity application may update the interface to omit the third ‘Description’ object 708 as shown in document interface 710. In some implementations, the productivity application may update the document tree to omit the third the ‘Description’ object 708.

In some implementations, the productivity application may receive input indicating the deletion of the content associated with an object, which may include the deletion of content associated with one or more objects included in the object. For example, the productivity application may receive input indicating the deletion of the content associated with second ‘Description’ object 706, deletion of the content associated with first ‘Description’ object 704, and deletion of the content associated with ‘Section’ ‘Title’ object 702. The productivity application may update the interface, as shown in document interface 720, to omit the deleted content and to include a placeholder token 722 representing the ‘Section’ object. In some implementations, the productivity application may update the document tree to omit the ‘Section’ object, the first ‘Description’ object, and the second ‘Description’ object.

In some implementations, the productivity application may receive input changing the association of content from one object to another. For example, the third ‘Description’ object 708 shown in document interface 700 may have focus, the productivity application may receive input indicating text, such as the text ‘A Second Section Title’, and input, such as the tab key or the shift-tab key sequence, indicating a change in association for the content from the ‘Description’ object 708, to a ‘Title’ object of a ‘Section’ object. The productivity application may update the interface, as shown in document interface 730, to omit the third ‘Description’ object, and to include the text as the content of a ‘Title’ object of a second ‘Section’ object 732 in place of the omitted third ‘Description’ object. In some implementations, the productivity application may update the document tree to omit the third ‘Description’ object, to include the second ‘Section’ object, to associate the content with the second ‘Section’ object, and to change the association for the second ‘Description’ object from the first ‘Section’ object, to the second ‘Section’ object.

In some implementations, the productivity application may receive input changing the relative horizontal positioning, or indentation, of an object. For example, the third ‘Description’ object 708 shown in document interface 700 may have focus, the productivity application may receive input indicating an increase in indentation, such as the tab key. The productivity application may update the interface to increase the indentation of the third ‘Description’ object 708, as shown in document interface 740. Although not explicitly shown in FIG. 7, the productivity application may receive input indicating a decrease in indentation, such as the shift-tab key sequence, and the productivity application may update the interface to decrease the indentation of the current object.

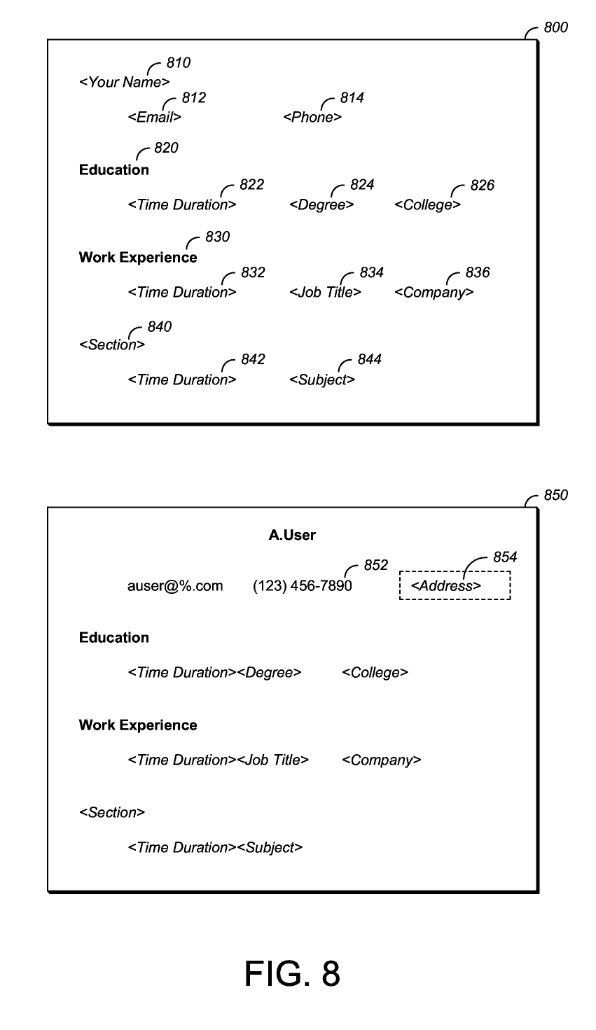

For simplicity, FIGS. 8-10 are described in relation to Template 3, which may be expressed as the following:

Resume=Name ContactInfo Education Experience Section+

Name=text [“Your Name”]

ContactInfo=Email Phone Address?

Email=text [“Email”]

Phone=text[“Phone”]

Address=text[“Address”]

Education=EducationTitle EducationItem+

EducationTitle=“Education”

EducationItem=Duration Degree College

Duration=text[“Time duration”]

Degree=text[“Degree”]

College=text[“College”]

Experience=ExperianceTitle Job+

ExperienceTitle=“Work Experience”

Job=Duration JobTitle Company Description?

Duration=text[“Time duration”]

JobTitle=text [“Job Title”]

Company=text [“Company”]

Description=text+

Section=Title Item+

Title=text[“Section”]

Item=Duration Subject

Duration=text[“Time duration”]

Subject=text[“Subject”] [Template 3]

FIG. 8 shows another diagram of an example of a portion of an interface for template-aware document editing of a document generated based on a template in accordance with implementations of this disclosure. For example, a document generated based on Template 3 may be output as a document interface 800 as shown in FIG. 8.

In some implementations, an object definition may include express content. For example, in Template 3, the ‘EducationTitle’ object includes a the express content “Education” delimited using the string modifier, and the ‘ExperienceTitle’ object includes the express content “Work Experience” delimited using the string modifier. In some implementations, a document generated based a template that includes express content, such as Template 3, may include the express content. In some implementations, the productivity application may include the express content in the interface as content.

For example, as shown in FIG. 8, the document interface 800 includes a ‘Your Name’ placeholder token 810 representing the ‘Name’ object, an ‘Email’ placeholder token 812 representing the ‘Email’ object, a ‘Phone’ placeholder token 814 representing the ‘Phone object, the ‘Education’ express content 820, a ‘Time Duration’ placeholder token 822 representing the ‘Duration’ object of a first ‘EducationItem’ object, a ‘Degree’ placeholder token 824 representing the ‘Degree’ object of the first ‘EducationItem’ object, a ‘College’ placeholder token 826 representing the ‘College’ object of the first ‘EducationItem’ object, the ‘Work Experience’ express content 830, a ‘Time Duration’ placeholder token 832 representing the ‘Duration’ object of a first ‘Job’ object, a ‘Job title’ placeholder token 834 representing the ‘JobTitle’ object of the first ‘Job’ object, a ‘Company’ placeholder token 836 representing the ‘Company’ object of the first ‘Job’ object, a ‘Section’ placeholder token 840 representing the ‘Title’ object of a first ‘Item’ object of the first ‘Section’ object, a ‘Time duration’ placeholder token 842 representing the ‘Duration’ object of the first ‘Item’ object of the first ‘Section’ object, and a ‘Subject’ placeholder token 844 representing the ‘Subject’ object of the first ‘Item’ object of the first ‘Section’ object.

In some implementations, a template, such as Template 3, may include an optional object, which may be indicated by the optional modifier. For example, in Template 3 the ‘ContactInfo’ object includes an optional ‘Address’ object. In some implementations, the productivity application may omit the optional object from the interface, as shown in document interface 800. In some implementations, the productivity application may receive input setting focus on the optional object. For example, the ‘Phone’ object 814 may have focus, the productivity application may receive input indicating text, such as a phone number, and including a completion identifier. The productivity application may update the interface, as shown in document interface 850, to include the text as content 852 for the ‘Phone’ object, and to include a placeholder token 854 for the optional ‘Address’ object. In some implementations, the productivity application may update the document tree to include the received text 852, the placeholder token 854, or both. In some implementations, the productivity application may receive input including a completion indicator for the ‘Address’ object 854, may determine that the ‘Address’ object 854 is not associated with content, and may update the interface to omit the optional ‘Address’ object. In some implementations, the productivity application may update the document tree to omit the optional ‘Address’ object.

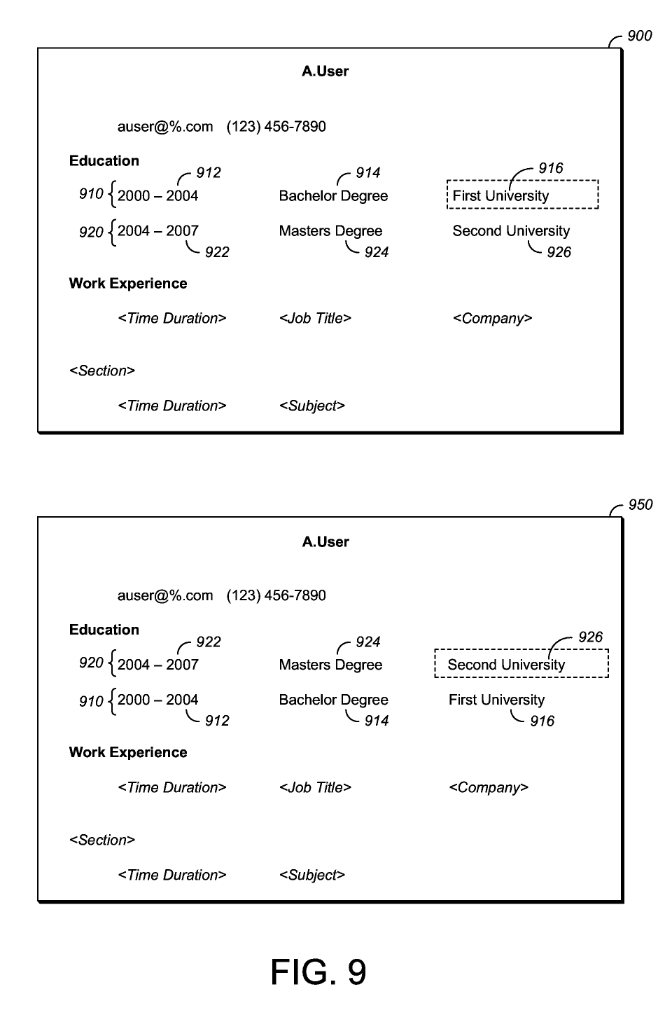

FIG. 9 shows another diagram of an example of a portion of an interface for template-aware document editing of a document generated based on a template in accordance with implementations of this disclosure. For example, a document generated based on Template 3 may be output as a document interface 900 as shown in FIG. 9.

In some implementations, the relative position of two instances of an object may be swapped. For example, as shown in document interface 900, a document may include a first instance of an ‘EducationItem’ object 910, which may include a first instance of a ‘Duration’ object 912, a first instance of a ‘Degree’ object 914, and a first instance of a ‘College’ object 916. The document may include a second instance of the ‘EducationItem’ object 920, which may include a second instance of a ‘Duration’ object 922, a second instance of a ‘Degree’ object 924, and a second instance of a ‘College’ object 926. In an example, the first instance of the ‘Duration’ object 912, the first instance of the ‘Degree’ object 914, or the first instance of the ‘College’ object 916 may have focus, the productivity application may receive input indicating a position change, such as the Alt-Down key sequence, and the productivity application may swap the relative position of the first ‘EducationItem’ object 910 with the second ‘EducationItem’ object 920, as shown in document interface 950. In another example, the second instance of the ‘Duration’ object 922, the second instance of the ‘Degree’ object 924, or the second instance of the ‘College’ object 926 may have focus, the productivity application may receive input indicating a position change, such as the Alt-Up key sequence, and the productivity application may swap the relative position of the second ‘EducationItem’ object 920 with the first ‘EducationItem’ object 910. In some implementations, the productivity application may update the document tree to indicate the position information.

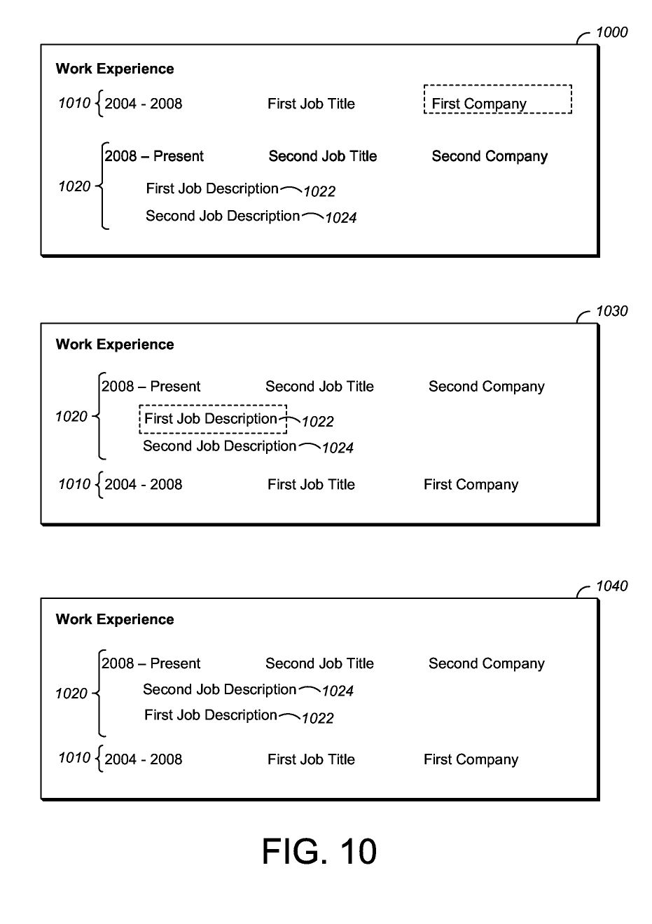

FIG. 10 shows another diagram of an example of a portion of an interface for template-aware document editing of a document generated based on a template in accordance with implementations of this disclosure. For example, a document generated based on Template 3 may be output as a document interface 1000 as shown in FIG. 10.

In some implementations, the relative position of two instances of an object may be swapped within another object. For example, as shown in document interface 1000, a document may include a first instance of a ‘Job’ object 1010, which may include a first instance of a ‘Duration’ object, a first instance of a ‘JobTitle’ object, and a first instance of a ‘Company’ object. The document may include a second instance of the ‘Job’ object 1020, which may include a second instance of the ‘Duration’ object, a second instance of the ‘JobTitle’ object, a second instance of the ‘Company’ object, a first instance of a ‘Description’ object 1022 for the second ‘Job’ object, and a second instance of the ‘Description’ object 1024 for the second ‘Job’ object.

In an example, the first instance of the ‘Duration’ object, the first instance of the ‘JobTitle’ object, or the first instance of the ‘Company’ object may have focus, the productivity application may receive input indicating a position change, such as the Alt-Down key sequence, and the productivity application may swap the relative position of the first ‘Job’ object 1010 with the second ‘Job’ object 1020, as shown in document interface 1030. In some implementations, the productivity application may update the document tree to indicate the position information.

In another example, the first instance of the ‘Description’ object 1022 for the second ‘Job’ object, or the second instance of the ‘Description’ object 1024 for the second ‘Job’ object may have focus as shown in document interface 1030, the productivity application may receive input indicating a position change, such as the Alt-Up key sequence, and the productivity application may swap the relative position of the first instance of the ‘Description’ object 1022 for the second ‘Job’ object and the second instance of the ‘Description’ object 1024 for the second ‘Job’ object as shown in document interface 1040. In some implementations, the productivity application may update the document tree to indicate the position information.

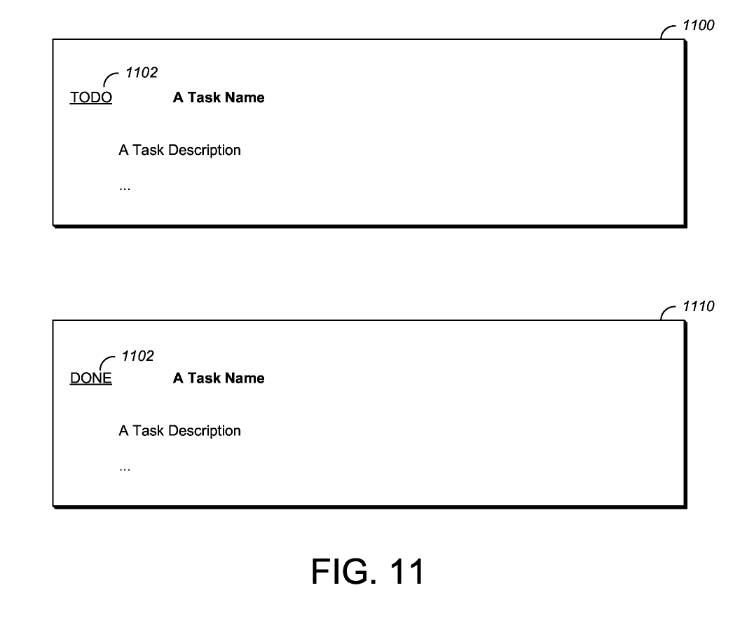

FIG. 11 shows another diagram of an example of a portion of an interface for template-aware document editing of a document generated based on a template in accordance with implementations of this disclosure. For example, a document generated based on Template 1 may be output as a document interface 1100 as shown in FIG. 11.

In some implementations, an object, such as the ‘Status’ object 1102 shown in FIG. 11, may include a set of objects that are associated with an alternate modifier, such as (Pending|Finished), and the content included in the document and the interface may be alternated between the objects. For example, the content “TODO” of the ‘Status’ object 1102 may have focus, the productivity application may receive input indicating a change in the content, such as the Tab key or the shift-tab key sequence, and the productivity application may update the interface to omit the content ‘TODO’ and include the content ‘DONE’ as shown in document interface 1110. In some implementations, the productivity application may update the document tree to omit the content ‘TODO’ and include the content ‘DONE’. In some implementations, alternating between the objects may include indicating that an object is an active object and indicating that another object is an inactive objet.

In some implementations, the productivity application may distinguish the content of objects associated with an alternate modifier in the interface. For example, a first alternate may be output using a first style, such as red font color, and a second alternate may be output using a different style, such as green font color. For clarity, the ‘TODO’ and ‘DONE’ content is shown underlined.

Although not shown in FIGS. 5-11, template-aware document editing may include validating content. For example, a date format may be defined for a date object and content input for an instance of the date object may be validated against the defined date format. In some implementations, content may be included in a document based on an external data source, such as a database. For example, a document may include a user identification object, the productivity application may receive input indicating content for the user identification object, such as a user ID, and the productivity application may receive content for one or more other objects, such as a user name object or an e-mail object, from an external data source based on the user ID.

Other implementations of the diagram of template-aware document editing as shown in FIGS. 4-11 are available. In implementations, additional elements of template-aware document editing can be added, certain elements can be combined, and/or certain elements can be removed. For example, in some implementations, generating a document tree as shown at 440 in FIG. 4 can be skipped and/or omitted.

Template-aware document editing, or any portion thereof, can be implemented in a device, such as the computing device 100 shown in FIG. 1. For example, a processor, such as the processor 140 shown in FIG. 1, can implement template-aware document editing, or any portion thereof, using instruction, such as the instructions 160 shown in FIG. 1, stored on a tangible, non-transitory, computer readable media, such as the memory 150 shown in FIG. 1.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, not all elements of the methods described herein may be required to implement a method in accordance with the disclosed subject matter.

The implementations of the computing and communication devices as described herein (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the computing and communication devices do not necessarily have to be implemented in the same manner.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

1. A method comprising:
identifying, by a computing device, a document template, the document template including rules, each rule including an object and an object definition;
generating, by the computing device, a document based on the document template, the document including document tokens, wherein each of the document tokens is generated based on a respective rule from the rules;
generating, by the computing device, a document tree based on the rules included in the document template, the document tree including document tree tokens respectively corresponding to the document tokens included in the document and indicating respective relationships between the document tokens as defined in the rules;
outputting, by the computing device and for display, a word processing document interface that includes a plurality of content placeholder elements, each content placeholder element corresponding to a respective token from the document tokens of the document;
receiving, by the computing device, user input that sets an interface focus on a first content placeholder element from the plurality of content placeholder elements;
outputting, by the computing device and for display in response to the user input that sets the interface focus on the first content placeholder element, a text entry interface element within the word processing document interface at the location of the first content placeholder element;
receiving, by the computing device, user input of a user content element made with respect to the text entry interface element;
replacing the first content placeholder element with the user content element such that the first content placeholder element is no longer output for display in the word processing document interface;
altering, by the computing device, the document tree to indicate the user content in response to receiving the user input, the user content replacing a place holder document tree token in the document tree; and
storing or transmitting the document by the computing device.

2. The method of claim 1, wherein each of the rules includes an object and an object definition for the object.

3. The method of claim 2, wherein a first rule from the rules includes a first object and an object definition for the first object, and wherein the object definition for the first object includes a second object.

4. The method of claim 3, wherein the second object is a custom object, and wherein a second rule from the rules includes the second object and an object definition for the second object.

5. The method of claim 3, wherein the second object is a system object, and wherein the second object is defined outside the document template.

6. The method of claim 3, wherein the object definition for the first object includes a modifier associated with the second object.

7. The method of claim 6, wherein the modifier is a one-or-more modifier, and wherein altering the document tree includes:
including content associated with a first instance of the second object in the document; and
including a document token associated with a second instance of the second object in the document.

8. The method of claim 6, wherein the modifier is an optional modifier, and wherein altering the document tree further includes:
including content associated with an instance of another object in the document, wherein the other object immediately precedes the second object the document template; and
including a document token associated with an instance of the second object in the document.

9. The method of claim 6, wherein the modifier is an alternate modifier, and wherein the object definition for the first object includes a third object that is associated with the alternate modifier, and wherein altering the document tree includes:
indicating that an instance of the third object is active; and
indicating that an instance of the second object is inactive.

10. The method of claim 2, wherein a first rule from the rules includes a first object and an object definition for the first object, and wherein the object definition for the first object includes a string of text, and wherein the document includes the string of text as content representing the first object.

11. The method of claim 2, wherein generating the document includes:
receiving the document; and
identifying a content element from the document, wherein the content element is associated with an instance of an object indicated in the document template.

12. The method of claim 11, wherein generating the document tree includes:
for each rule in the rules:
on a condition that the object definition for the object of the respective rule includes content, including the content as a content element associated with an instance of the respective object in the document tree;
on a condition that the document includes a content element associated with an instance of the object of the respective rule, including the content element in the document tree; and
on a condition that the object definition for the object of the respective rule does not include content and that the document does not include a content element associated with an instance of the object, including a placeholder token representing the object in the document tree.

13. The method of claim 2, wherein the document includes a first instance of an object and a second instance of the object, and wherein altering the document tree includes replacing the first instance of the object with the second instance of the object and replacing the second instance of the object with the first instance of the object.

14. The method of claim 2, wherein a first rule from the rules includes a first object and an object definition for the first object, wherein the object definition for the first object includes a second object and a third object.

15. The method of claim 14, wherein the document tree includes an object instance associated with the third object, and wherein altering the document tree includes:
removing, from the document tree, the association between the object instance and the third object; and
inserting, into the document tree, an association between the object instance and the second object.

16. The method of claim 1, wherein the rules include a sequence, and wherein generating the document based on the document template includes processing the rules based on the sequence.

17. A method comprising:
identifying, by a computing device, a document template, the document template including rules, wherein each rule in the rules includes an object and an object definition for the object, and wherein a first rule from the rules includes a first object and an object definition for the first object, wherein the object definition for the first object includes a second object;
generating, by the computing device, a document based on the document template, the document including document tokens, wherein each of the document tokens is generated based on a respective rule from the rules;
generating, by the computing device, a document tree based on the rules included in the document template, the document tree including document tree tokens respectively corresponding to the document tokens included in the document and indicating respective relationships between the document tokens as defined in the rules;
outputting, by the computing device and for display, a word processing document interface that includes a plurality of content placeholder elements, each content placeholder element corresponding to a respective token from the document tokens of the document;
receiving, by the computing device, user input that sets an interface focus on a first content placeholder element from the plurality of content placeholder elements, wherein the first content placeholder element is associated with a first document token from the document tokens;
outputting, by the computing device and for display in response to the user input that sets the interface focus on the placeholder element, a text entry interface element within the word processing document interface at the location of the first content placeholder element;
receiving, by the computing device, user input of a user content element made with respect to the text entry interface element, wherein the computing device associates the user content element with the first document token from the document tokens;
replacing the first content placeholder element with the user content element such that the first content placeholder element is no longer output for display in the word processing document interface;
altering, by the computing device, the document tree to indicate the user content in response to receiving the user input, the user content replacing a place holder document tree token in the document tree; and
storing or transmitting the document by the computing device.

18. The method of claim 17, wherein the object definition for the first object includes a modifier associated with the second object.

19. The method of claim 17, wherein a second rule from the rules includes an object definition for the second object, and wherein generating the document tree includes:
on a condition that the object definition for the second object includes content, including the content as a content element associated with an instance of the second object in the document tree;
on a condition that the document includes a content element associated with an instance of the second object, including the content element in the document tree; and
on a condition that the object definition for the second object does not include content and that the document does not include a content element associated with an instance of the second object, including a placeholder token representing the second object in the document tree.

20. A method comprising:
identifying, by a computing device, a document template, the document template including rules, wherein each rule in the rules includes an object and an object definition for the object, and wherein a first rule from the rules includes a first object and an object definition for the first object, wherein the object definition for the first object includes a second object;
generating, by the computing device, a document based on the document template, the document including document tokens, wherein each of the document tokens is generated based on a respective rule from the rules, wherein generating the document includes generating a document tree based on the rules and the document, the document tree including document tree tokens respectively corresponding to the document tokens included in the document and indicating respective relationships between the document tokens as defined in the rules, and wherein the rules includes a sequence, and wherein generating the document tree includes processing the rules based on the sequence;
outputting, by the computing device and for display, a word processing document interface that includes a plurality of content placeholder elements, each content placeholder element corresponding to a respective token from the document tokens of the document;
receiving, by the computing device, user input that sets an interface focus on a first content placeholder element from the plurality of content placeholder elements, wherein the first content placeholder element is associated with a first document token from the document tokens;
outputting, by the computing device and for display in response to the user input that sets the interface focus on the first content placeholder element, a text entry interface element within the word processing document interface at the location of the first content placeholder element;
receiving, by the computing device, user input of a user content element made with respect to the text entry interface element;
replacing the first content placeholder element with the user content element such that the first content placeholder element is no longer output for display in the word processing document interface;
altering, by the computing device, the document tree to indicate the user content in response to receiving the user input, the user content replacing a place holder document tree token in the document tree; and
storing or transmitting the document by the computing device.
